(19) United States
(12) Patent Application Publication
(10) Pub. No.: US 2017/0160243 A1
(43) Pub. Date: Jun. 8, 2017

(54) Device and System for Structural Health Monitoring

(71) Applicant: Broadsens Corp., Sunnyvale, CA (US)

(72) Inventors: Chang Zhang, San Jose, CA (US); Lei Liu, San Ramon, CA (US)

(73) Assignee: Broadsens Corp., Sunnyvale, CA (US)

(21) Appl. No.: 15/360,894

(22) Filed: Nov. 23, 2016

Related U.S. Application Data
(60) Provisional application No. 62/261,866, filed on Dec. 2, 2015.

(51) Int. Cl. G01N 29/44; G01N 29/24; G01N 29/04

(52) U.S. Cl. CPC G01N 29/4427; G01N 29/04; G01N 29/2412; G01N 29/2437; G01N 2291/0289

(57) ABSTRACT

The present invention discloses a smart structural health monitoring device. The device is an intelligent sensor device mounted onto or near the structure to be monitored. The device includes an actuating unit that generates acoustic or ultrasonic excitation signals across the structure, a sensor unit that receives the structure's responses to the excitation signals and generates corresponding sensor data, a processing unit that determines the structure's structural health (e.g., structural change, structural defect, structural damage) by processing the sensor data with analytics algorithms. The smart device also includes at least a non-volatile memory (e.g., Flash memory) for storing the structural health information and sensor data. Such a smart structural health monitoring device is capable of independently determining the structural changes and damages. And multiple smart structural health monitoring devices can be used for monitoring one or more structures at the same time. A remote management console is used to configure, schedule, coordinate, and control the devices through a network. Each device transmits the results of structural changes and damages to the remote management console through according to a schedule or upon request.

### CROSS-REFERENCE TO RELATED APPLICATION

This application claims priority to U.S. provisional patent application Ser. No. 62/261,866, filed Dec. 2, 2015, the entire content of which is incorporated herein by reference.

### FIELD OF INVENTION

This invention generally relates to the field of structural health monitoring (“SHM”).

### BACKGROUND OF THE INVENTION

SHM involves the process of implementing a damage detection and characterization strategy for engineering structures. Such damages may include changes to the material and/or geometric properties of a structural system as well as changes to the boundary conditions and system connectivity, which adversely affect the structural system's performance. The monitoring process may include the observation of a system over time using periodically sampled dynamic response measurements from an array of sensors, the extraction of damage-sensitive features from these measurements, and the statistical analysis of these features to determine the current state of system health.

Currently, a SHM system includes data acquisition devices and at least one processing device, such as a computer, that is separate from the data acquisition devices. These data acquisition devices are usually mounted onto or installed near a structure to be monitored. In passive mode SHM systems, these data acquisition devices include in-situ sensors which listen to the changes continuously or periodically. In active mode SHM systems, however, these data acquisition devices include not only in-situ sensors but also actuators. The actuators use waveform generators and power amplifiers to generate actuation signals and send the actuation signals to the structure, whereas the in-situ sensors listen to the actuation signals and send back sensor signals for measurement. When the structure is normal, the sensor signals are used as the baseline data. When the structure has defects or changes, the sensor signals would be different from the baseline data. These data acquisition devices either integrate the actuator(s) and/or sensor(s) inside or connect to them externally. However, these data acquisition devices do not have the capabilities to determine the structural changes and damages independently. Active mode SHM system relies on the separate processing device(s) to perform relevant analysis and determine if the structure has experienced any change, defect, or damage. To achieve this goal, these data acquisition devices transmit the raw sensor data to the processing device(s) via a network or pre-processes the raw sensor data through some filtering or data compression process before the transmission via the network. The processing device(s) then determines the structural changes and damages based on the raw or pre-processed sensor data received from the data acquisition devices. However, the network connectivity becomes the critical point of the system. Any network glitches or failure will disrupt the monitoring of the structure. Since all sensor data, either in raw format or in pre-processed format, need to be transmitted to the processing device for analysis, the requirement for network bandwidth and processing power of the processing device grows dramatically as the number of data acquisition devices increases. This makes SHM systems difficult to scale. In addition, for a very large structure, a large number of such SHM devices are required. When each smart SHM device sends raw data to a processing device for analysis, the processing device will need to perform heavy data processing and it could take a very long time for the processing device to find the result. In time critical situations, any critical damage to the structure may not be timely detected.

### SUMMARY OF THE INVENTION

The present invention discloses a smart SHM device with built-in intelligence. The device is capable of detecting events, processing sensor data, extracting features, executing analytics algorithms, and determining structural changes and damages all by itself. Such events include, but are not limited to, impacts, pressure, strains, load changes, vibrations, accelerations, decelerations, temperature changes, motions, light, humidity changes, etc. Features that may be extracted from the sensor data include, but are not limited to, frequency, energy, waveform envelope, peak points, and zero crossing points. The structural changes and damages that may be determined by the smart SHM device include, but are not limited to, cracks, delamination, deformations, corrosions, erosions, leakages, bolt loosening, movements, bending, etc.

In one embodiment of the present invention, a plurality of the smart SHM devices is connected to a remote management console through a network. The console may be a computer or a mobile computing device with necessary software deployed on it. The remote management console provides central management for those smart SHM devices, including but not limited to baseline adjustment, data acquisition setup, threshold adjustment, removing data, time clock synchronization, user management. The remote management console also systematically downloads useful analytic results or data from these devices and coordinates the collaboration and operation of these smart SHM devices.

This invention integrates data acquisition and data processing into a single smart device, which greatly simplifies the electrical wiring need, reduces the overall footprints, and improves the reliability of a SHM system. The baseline information regarding the structure when it is in healthy condition is stored locally at the SHM device. A predefined threshold is also stored locally in the SHM device. The baseline information is used to determine if the structure defects exceed the safety operation boundary. The detection of structural changes and damages is performed directly by the smart SHM device. This allows instantaneous event detection in the shortest time frame, which is especially useful at time critical situations where the decision must be made as fast as possible. Because the detection of structural changes and damages is performed locally, a smart SHM device can continuously monitor a structure to detect damage, even when network connection is not available.

The smart SHM device does not need to send all sensor data to the remote management console across the network for processing. The sensor data, extracted features, and results of structural changes and damages are transmitted to the remote management console only when requested or scheduled. This dramatically reduces the load on the network infrastructure.

In one embodiment of the present invention, the sensor data and analytic results are stored in a memory module of the smart SHM device during network down time and are sent across network when the network connection is recovered. This significantly improves overall system reliability.

The ability to distribute heavy processing at the device level significantly improves the system scalability. In one embodiment of the present invention, multiple smart SHM devices are deployed to monitor a large structure. The ability of parallel processing by these smart SHM devices provides the fastest response speed for the monitoring of the large structure. Likewise, multiple smart SHM devices can be used to monitor a very important structure to add redundancy for maximizing the reliability.

In one embodiment of the present invention, the smart SHM device provides a sleep mode for saving power, especially when the device is operated by battery power. When in sleep mode, the smart SHM device's processing unit, actuating unit, and communication unit go into sleep, leaving one or just a few sensors in monitoring mode. The sensor(s) consumes very little power to conserve energy. When an event is detected, the device wakes up and starts processing the event.

In one embodiment of the present invention, the smart SHM device is operated by battery power. This is useful in situations where external power supply is not conveniently available for the device. In another embodiment of the invention, the smart SHM device is powered by either AC or DC power from the power source on the structure or close to the structure.

In one embodiment of the present invention, the device is permanently mounted onto or close to the structure to be monitored with fixture such as screws, epoxy, metal belts, or clamps, or soldering, etc.

In one embodiment of the present invention, the device has self-diagnosis ability and sensor diagnosis ability.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings. Additionally, the leftmost digit of a reference number identifies the drawing in which the reference number first appears.

FIG. 1 is a block diagram of a smart SHM device in accordance with an embodiment of the present invention.

FIGS. 2A and 2B are block diagrams of an actuating unit in accordance with an embodiment of the present invention.

FIGS. 3A-3D are block diagrams of a sensor unit in accordance with an embodiment of the present invention.

FIG. 4 is a block diagram of the hardware components of a smart SHM device in accordance with an embodiment of the present invention.

FIG. 5 shows a scenario where multiple smart SHM devices is connected with and managed by a remote management console via a network.

### DETAILED DESCRIPTION

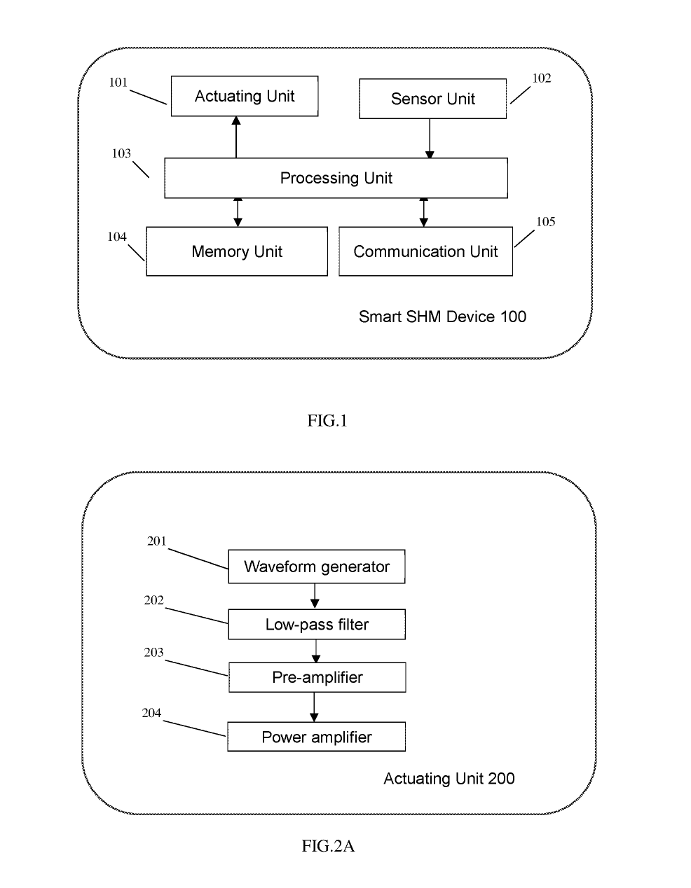

FIG. 1 illustrates a block diagram of a smart SHM device according to one embodiment of the invention. As shown, the smart SHM device 100 includes an actuating unit 101, a sensor unit 102, a processing unit 103, a memory unit 104, and a communication unit 105.

The actuating unit 101 and sensor unit 102 may include piezoelectric-based actuators and sensors or Electromagnetic Acoustic Transducer (EMAT)-based actuators and sensors, respective. In one embodiment of the invention, the actuating unit 101 and sensor unit 102 are installed inside the smart SHM device 100. During operation, the actuating unit 101 sends excitation signals across the structure and the sensor unit 102 receives the structure's response to the excitation signals. Alternatively, the actuating unit 101 and/or the sensor unit 102 may be connected externally to the smart SHM device 100 via connecters and/or cables. In this configuration, the actuating unit 101 and the sensor unit 102, or a number of these units, may be easily deployed at specific location(s) of the structure, where it would be difficult to fit the whole smart SHM device due to space restraints.

In one embodiment of the invention, the sensor unit 102 may include multiple sensors with different sensing capabilities, such as accelerometer, strain gauge sensor, motion sensor, temperature sensor, humidity sensor, pressure sensor, gyro sensor, force sensor, light sensor, audio sensor, biometrics sensor, proximity sensor, current sensor, magnetic sensor, acoustic sensor, ultrasonic sensor, GPS sensor, and others.

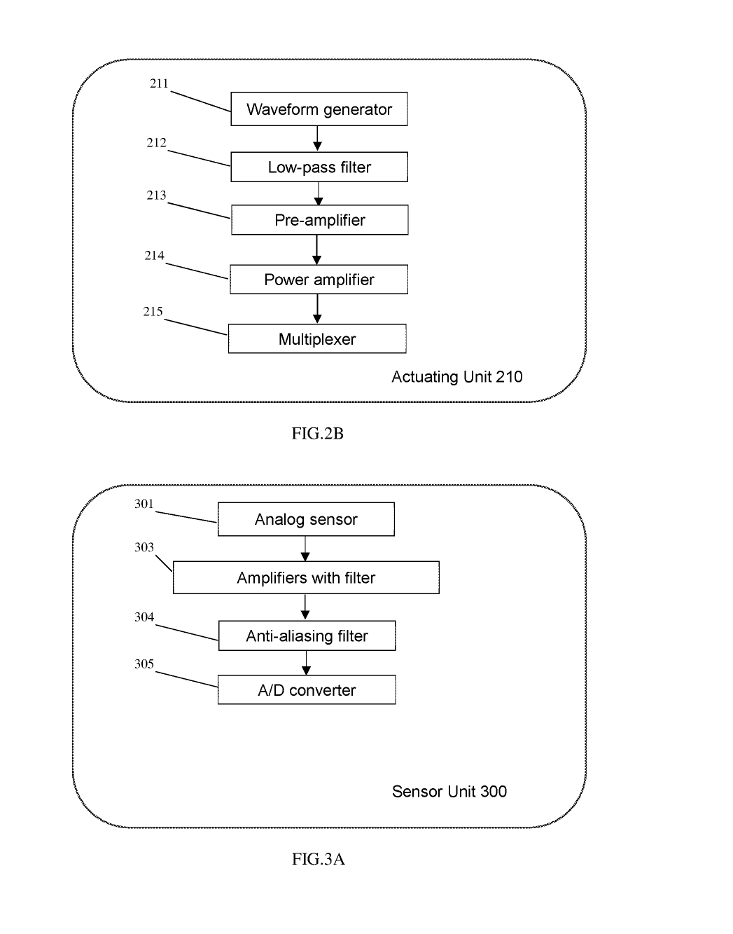

FIG. 2A is a block diagram of an actuating unit according to one embodiment of the present invention. As shown, the actuating unit 200 includes a waveform generator 201, a low-pass filter 202, a pre-amplifier 203, and a power amplifier 204. The waveform generator 201 generates diagnostic waveforms. Then, the low-pass filter 202 removes high frequency noise from the waveforms. After that, the pre-amplifier 203 amplifies the waveforms to a higher level. And finally, the power amplifier 204 generates the high power waveforms based on the previously processed waveforms and sends the high power waveforms to the monitored structure.

FIG. 2B is a block diagram of an actuating unit with a different design from the actuating unit illustrated in FIG. 2A. The actuating unit 210 includes a waveform generator 211, a low-pass filter 212, a pre-amplifier 213, a power amplifier 214, and a multiplexer 215. The multiplexer 215 can switch actuation signals to a plurality of transducers.

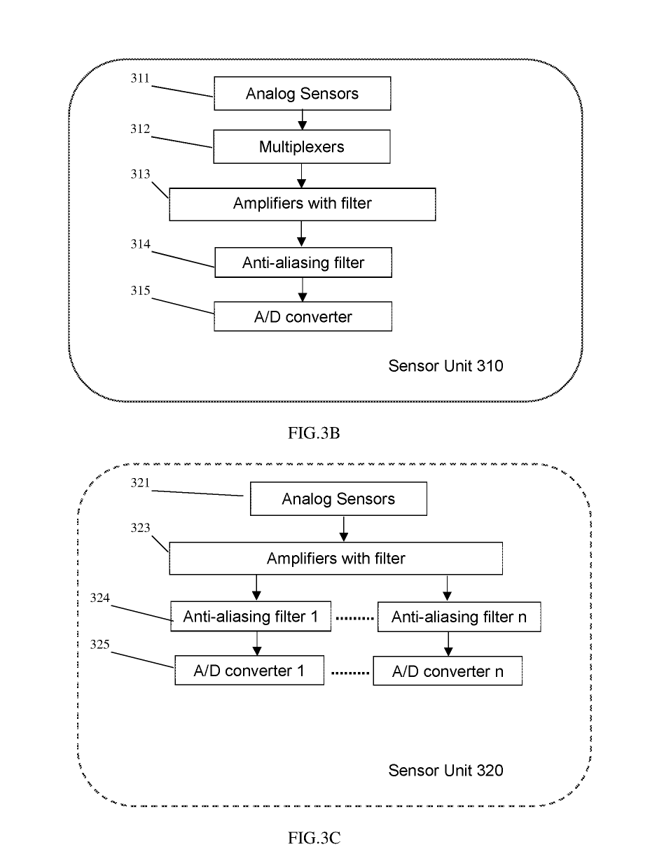

FIG. 3A is a block diagram of a sensor unit according to one embodiment of the present invention. As shown, the sensor unit 300 includes an analog sensor 301, one or more amplifiers with filter 303, an anti-aliasing filter 304, and an analog to digital converter (A/D) 305. The analog sensor 301 can be piezoelectric sensor, EMAT sensor, accelerometer, strain gage, temperature sensor, humidity sensor, sound sensor, pressure sensor, etc. The one or more amplifiers with filter 303 amplifies sensor signals and removes low-frequency and high frequency noises from the sensor signals. The anti-aliasing filter 304 reduces high-frequency noise in front of the A/D converter 305, which digitizes the sensor signals.

FIG. 3B is a block diagram of a sensor unit according to another embodiment of the present invention. As shown, the sensor unit 310 includes an analog sensor 311, one or more multiplexers 312, one or more amplifiers with filter 313, an anti-aliasing filter 314, and analog to digital converter (A/D) 315. The analog sensor 311 can be piezoelectric sensor, EMAT sensor, accelerometer, strain gage, temperature sensor, humidity sensor, Gyroscope, etc. The one or more multiplexers 312 can switch between multiple analog sensors, so that multiple sensors can share the same circuit after the multiplexer to reduce size and cost. The one or more amplifiers with filter 313 amplifies sensor signals and removes low-frequency and high frequency noises from the signals. The anti-aliasing filter 314 reduces high-frequency noise in front of the A/D converter 315, which digitizes the sensor signals.

FIG. 3C is a block diagram of a sensor unit according to yet another embodiment of the present invention. As shown, the sensor unit 320 includes multiple analog sensors 321, multiple amplifiers with filter 323, multiple anti-aliasing filters 324, and multiple analog to digital converters (A/Ds) 325. This implementation allows the smart SHM device to perform parallel data acquisition for multiple sensors.

FIG. 3D is a block diagram of a sensor unit according to yet another embodiment of the present invention. As shown, the sensor unit 330 includes one or more digital sensors 331 such as accelerometer, strain gage, temperature sensor, humidity sensor, GPS, gyroscope, barometer, etc. The digital sensors 331 can be connected to the processing unit, such as the one in FIG. 1, via digital interface such as I2C, SPI, USB or serial bus.

It should be noted that different variations of design of the actuating unit and/or the sensor unit may be achieved by combining and/or rearranging all or some of the above described embodiments and/or their components. For example, a plurality of analog sensors 301, amplifiers with filter 303, and digital sensors 331 can be combined into one sensor unit.

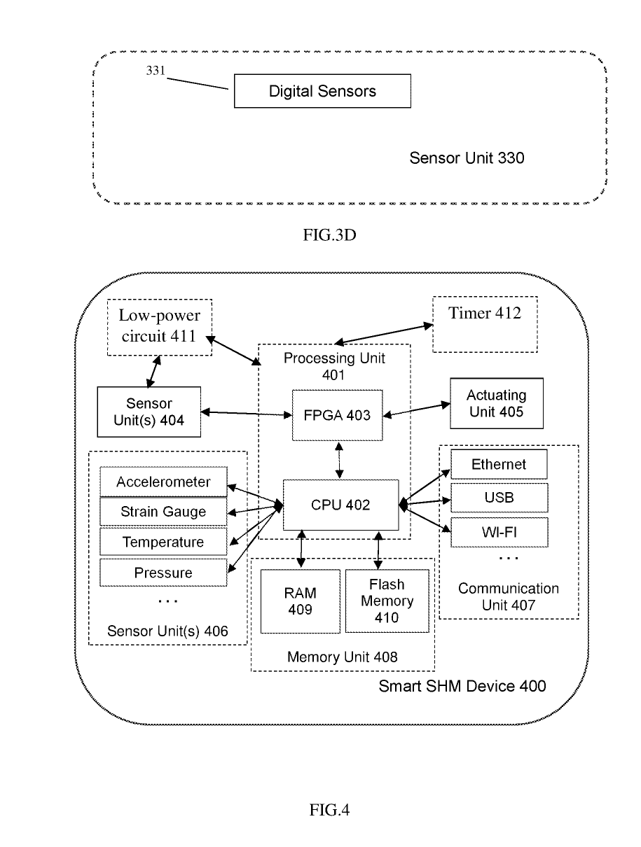

FIG. 4 is a block diagram of the hardware components of a smart SHM device in accordance with an embodiment of the present invention. As shown, the smart SHM device 400′s processing unit 401 includes a Field-Programable Gate Array (“FPGA”) 403 and a CPU 402. The FPGA 403 provides electronic logic interface to the sensor unit(s) 404. The CPU 402 can also interface with the sensor unit(s) 406 directly without using the FPGA 403. As shown in FIG. 4, the sensor unit(s) 406, and similarly the sensor unit(s) 404, may be an accelerometer, strain gauge sensor, motion sensor, temperature sensor, humidity sensor, pressure sensor, gyro sensor, force sensor, light sensor, audio sensor, biometrics sensor, proximity sensor, current sensor, magnetic sensor, acoustic sensor, ultrasonic sensor, GPS sensor, or any combination of the above.

The processing unit 401 controls the actuating unit 405 to send out excitation signals based on predefined schedules, user commands, or events detected from the sensor unit(s) 404 and/or sensor unit(s) 406. There are many ways to implement the processing unit 401. In one embodiment, the processing unit 401 detects structural changes by comparing new data with a baseline profile. The baseline profile may be created right after the installation of the smart SHM device 400 onto the structure or any maintenance of the structure has just been finished. When the change exceeds a predefined threshold, the processing unit 401 determines that a change or damage in structure has occurred and may cause an alarm to sound and send an alert message to a remote management console.

In another embodiment, the processing unit 401 calculates structural changes based on a pre-established structure model. When the change exceeds a predefined threshold, the processing unit 401 determines that a change or damage in the structure has occurred and may cause an alarm to sound and send an alert message to a remote management console. For example, statistical models for discrimination between features from the undamaged and damaged structures are established. Statistical model development is concerned with the implementation of the algorithms to quantify the damage state of the structure.

In yet another embodiment, the processing unit 401 can estimate structural changes and damages by using extracted feature data. Because the size of the feature data is much smaller than sensor data, only a fraction of network bandwidth, computational power, and memory are required. This significantly improves the response time of the smart SHM device. Feature data includes, but is not limited to, (1) the peak values of each cycle of a waveform; (2) the maximum and minimum values of each cycle of a waveform; (3) down-sampled data from the raw data; (4) the peak values of a waveform in a given window. For example, the total waveform has 6,000 data points and one is only interested in the data points in the window of [500, 2000].

In one embodiment, adaptive method such as machine learning algorithms can be used to adjust the schedule adaptively based on the structure status. For example, when the structure reaches a critical failure threshold, more frequent scanning can be scheduled automatically.

The memory unit 408 of the smart SHM device 400 may include volatile memory such as RAM 409 and/or non-volatile memory such as flash memory 410. The flash memory 410 (or other type of non-volatile memory) saves device configurations, baseline profiles, history data, as well as software programs that perform various tasks of data processing, analytics, data transmission, process management, hardware management, etc. History data includes sensor data, extracted features and events, detected structural changes and damages. In one embodiment, the flash memory 410 maintains a database that stores the baseline profiles, history data, and new data. The database has a predefined size limit and when the database becomes full, the oldest data will be erased first to leave space for new data. In addition, these stored data may be accessed from the remote management console, which is discussed in detail below.

The communication unit 407 of the smart SHM device 400 provides connectivity to other devices. In one embodiment of the invention, an Ethernet port is included. In other embodiments, other communication interfaces may be used, including but not limited to Wi-Fi, cellular network, Zigbee, Zwave, CAN bus, I2C, SPI, RS485, RS232, USB, and others.

In one embodiment of the invention, the smart SHM device 400 has an HDMI display interface to connect to an external monitor and host USB ports to connect to a keyboard and mouse. This provides a local user interface. Furthermore, the smart SHM device may carry a LED light, a LCD screen, a keypad, and/or an alarm. A user can use the keypad to configure the smart SHM device, including the LED light, LCD screen, and/or alarm, during installation. During operation, the LED light, LCD screen, and/or alarm can indicate the status and send alarm notifications when critical condition is detected.

In one embodiment of the present invention, the smart SHM device 400 provides a sleep mode for saving power, especially when the device is operated by battery power. When in sleep mode, the smart SHM device's processing unit, actuating unit, memory unit, and communication unit go into sleep, leaving one or just a few sensors in monitoring mode. The sensor(s) consumes very little power to conserve energy. When an event is detected, the device wakes up and starts processing the event.

For example, when the smart SHM device 400 goes into the sleep mode, the processing unit 401, the actuating unit 405, the memory unit 408, and the communication unit 407 go into sleep. Only one or more sensors (e.g., a piezoelectric sensor) and a low-power circuit 411 are still operating for monitoring certain events. In one case, such an event is a strong impact to the structure. When an impact event occurs, the piezoelectric sensor converts the mechanical energy to electrical signal. The conversion does not need external power due to the property of piezoelectric. When the voltage level of the electrical signal exceeds a predefined voltage level, the low-power circuit 411 sends a wake-up call to the processing unit 401 to wake up the whole SHM device 400.

In another example, the smart SHM device 400 goes into the sleep mode and wakes up periodically controlled by an internal timer 412 that consumes very low power. The sleeping period may be specified and adjusted by users.

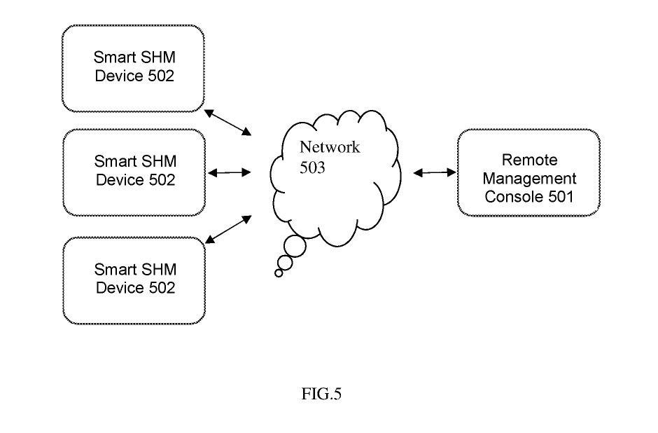

FIG. 5 shows a scenario where a plurality of smart SHM devices is connected to and managed by a remote management console via a network. As shown, a remote management console 501 is connected to a plurality of smart SHM devices 502 through network 503. The remote management console 501 may be a computer or a mobile computing device with necessary software installed on it. The remote management console 501 provides central management for those smart SHM devices 502, systematically downloads useful analytic results or data from these devices, and coordinates the collaboration and operation of these smart SHM devices. Upon requests or planed schedules, one or more of the smart SHM devices 502 transmit results of structural changes and damages to the remote management console 501 through their communication units and the network 503. The remote management console 501 may also selectively request sensor data, extracted features and events, and results of structural changes and damages from any of these devices. For example, a copy of the database maintained in each smart SHM device's memory unit is stored and maintained in the remote management console 501. Because the remote management console 501 could have a much larger memory space, it may not be necessary to remove the old data to provide storage space for new data. As such, only data from a predefined period of time and the baseline profile are synchronized between the two copies.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

We claim:

1. A smart structural health monitoring device for detecting structural changes and damages of a structure, the device comprising:
an actuating unit for generating and sending an excitation signal across the structure;
a sensor unit for receiving the structure's response to the excitation signal and generating sensor data based on the response; and
a processing unit for determining the structure's structural health based on the sensor data.

2. The device of claim 1, wherein said excitation signal comprises one of an acoustic signal and an ultrasonic signal.

3. The device of claim 2, wherein said structural health comprises information on at least one of a structural change, a structural defect, and a structural damage of the structure.

4. The device of claim 3 further comprising a memory unit for storing the sensor data and the structural health and a communication unit for communicating with other devices.

5. The device of claim 4 further comprising a housing that contains at least the processing unit, the actuating unit, the sensor unit, the memory unit, and the communication unit.

6. The device of claim 1, where a baseline data is used for normal structural state and the structural health is determined by comparing newly acquired sensor data to baseline data.

7. The device of claim 5, wherein the memory unit comprises at least one of a volatile memory and a non-volatile memory, and wherein the communication unit comprises at least one of an Ethernet interface, a Wi-Fi interface, a cellular network interface, a Zigbee interface, a Zwave interface, a CAN bus interface, an I2C interface, a SPI interface, a RS485 interface, a RS232 interface, and a USB interface.

8. The device of claim 1, wherein the actuating unit comprises a piezoelectric-based actuator and the sensor unit comprises a piezoelectric-based sensor.

9. The device of claim 1, wherein the actuating unit comprises an Electromagnetic Acoustic Transducer (EMAT)-based actuator and the sensor unit comprises an EMAT-based sensor.

10. The device of claim 1 further comprising at least one of an accelerometer, a strain gauge sensor, a motion sensor, a temperature sensor, a humidity sensor, a pressure and force sensor, a biometrics sensor, a gyro sensor, a light sensor, a magnetic sensor, an acoustic sensor, an ultrasonic sensor, a proximity sensor, a sound sensor, a current sensor, and a GPS sensor.

11. The device of claim 1 further comprising circuits for receiving battery power.

12. The device of claim 1 further comprising means for permanently mounting the device onto or near the structure by using one of a screw, an epoxy, a metal belt, a clamp, and soldering.

13. The device of claim 1 further comprising at least one of a LED light, a LCD screen, a keypad, and an alarm.

14. The device of claim 13 further comprising a first port for connecting to an external display and a second port for connecting to an external keyboard.

15. The device of claim 1 further comprising a low-powered circuit for generating and sending a wake-up signal to the processing unit to wake up the smart structural health monitoring device in response to an external event.

16. The device of claim 1 further comprising a timer for periodically causing the smart structural health monitoring device to go into sleep and then wake up according to a predetermined schedule.

17. A structural health monitoring system for detecting structural changes and damages of a structure, the system comprising:
a plurality of smart structural health monitoring devices, each device comprising:
an actuating unit for generating and sending an excitation signal across the structure,
a sensor unit for receiving the structure's response to the excitation signal and generating sensor data based on the response, and
a processing unit for determining the structure's structural health based on the sensor data; and
a remote management console, wherein the console sends instructions to the plurality of smart structural health monitoring devices to coordinate these devices and receives structural health results from these devices via a network.

18. The system of claim 17, wherein each smart structural health monitoring device further comprising a memory unit for storing the sensor data and the structural health and a communication unit for communicating with the remote management console, wherein the memory unit comprises a Random Access Memory and a Flash memory, and wherein the communication unit comprises at least one of an Ethernet interface, a Wi-Fi interface, a cellular network interface, a Zigbee interface, a Zwave interface, a CAN bus interface, an I2C interface, a SPI interface, a RS485 interface, a RS232 interface, and a USB interface.

19. The system of claim 18, wherein the actuating unit of each smart structural health monitoring device comprises one of a piezoelectric-based actuator and an Electromagnetic Acoustic Transducer (EMAT)-based actuator, and wherein the sensor unit of each smart structural health monitoring device comprises one of a piezoelectric-based sensor and an Electromagnetic Acoustic Transducer (EMAT)-based sensor.

20. The system of claim 19, wherein each smart structural health monitoring device further comprises at least one of an accelerometer, a strain gauge sensor, a motion sensor, a temperature sensor, a humidity sensor, a pressure and force sensor, a biometrics sensor, a gyro sensor, a light sensor, a magnetic sensor, an acoustic sensor, an ultrasonic sensor, a proximity sensor, a sound sensor, a current sensor, and a GPS sensor.
